(19) United States
(12) Patent Application Publication
(10) Pub. No.: US 2023/0074889 A1
(43) Pub. Date: Mar. 9, 2023

(54) DEPTH ESTIMATION METHOD AND DEPTH ESTIMATION DEVICE

(71) Applicant: Morpho, Inc., Tokyo (JP)

(72) Inventor: Ryotaro Kakuda, Tokyo (JP)

(73) Assignee: Morpho, Inc., Tokyo (JP)

(21) Appl. No.: 17/897,220

(22) Filed: Aug. 29, 2022

(30) Foreign Application Priority Data
Aug. 30, 2021 (JP) 2021-139951
Aug. 16, 2022 (JP) 2022-129542

(51) Int. Cl. G01B 11/22; G01S 17/89; G01C 11/04

(52) U.S. Cl. CPC G01B 11/22; G01S 17/89; G01C 11/04

(57) ABSTRACT

Examples of a depth estimation method include acquiring a plurality of depth maps, and outputting one output depth map obtained by compositing the plurality of depth maps with a lower average difference between distance values of adjacent pixels than in a case of directly using distance values included in the plurality of depth maps.

### CROSS-REFERENCE TO RELATED APPLICATION

The present application claims priority under 35 U.S.0 §119(a) to Japanese Patent Application No. 2021-139951 filed on Aug. 30, 2021, and Japanese Patent Application No. 2022-129542 filed on Aug. 16, 2022, which is hereby expressly incorporated by reference, in its entirety, into the present application.

### BACKGROUND

### 1. Technical Field

Examples are described which relate to a depth estimation method and a depth estimation device.

### 2. Related Art

An image captured by an image capturing device such as a camera expresses luminance information regarding a subject, whereas a depth map (also called a depth image) detected by a ranging sensor such as a ToF (Time of Flight) sensor or a LiDAR (Light Detection and Ranging) sensor expresses distance or depth information regarding the distance between the ranging sensor and a subject. Such a depth map can be used for, for example, photo processing performed on captured images, or object detection for autonomous operation of a vehicle, a robot, or the like. Advancements in AI (Artificial Intelligence) technology have been accompanied by the development of a depth estimation model for estimating a depth map representing the distance (i.e. depth) between a subject and an image capturing device based on an image acquired from the image capturing device. For example, MiDaS (https://github.com/intel-isl/MiDaS) and DPT (https://github.com/intel-isl/DPT) are known as depth estimation models for monocular images.

On the other hand, as the functionality of mobile terminals such as smartphones and tablets has improved in recent years, ranging sensors such as ToF sensors and LiDAR sensors are now being provided in mobile terminals. For example, JP2020-042772A discloses a processing system that performs alignment on depth maps acquired by a ToF sensor and a stereo camera and outputs an optimized depth map.

However, while a depth map acquired by a ToF sensor typically has accurate distance values, such a depth map can possibly have many missing pixels. On the other hand, while a depth estimation model that is based on a deep neural network outputs depth maps that are consistent overall, such a depth estimation model sometimes cannot obtain accurate distance values or read fine textures.

For this reason, simply supplementing missing pixels with use of a depth map acquired from a camera as in the technique in JP 2020-042772A results in an unnaturally prominent boundary between a pixel region that has distance values obtained by the ToF sensor and other pixel regions. In other words, a high-quality depth map cannot be acquired.

### SUMMARY

Some examples described herein may address the above-described problems. Some examples described herein may provide a depth estimation method and a depth estimation device capable of obtaining a high-quality depth map. In some examples, a depth estimation method includes acquiring a plurality of depth maps, and outputting one output depth map obtained by compositing the plurality of depth maps with a lower average difference between distance values of adjacent pixels than in a case of directly using distance values included in the plurality of depth maps.

### BRIEF DESCRIPTION OF THE DRAWINGS

FIG. 1 shows a depth estimation device;

FIG. 2 is a block diagram illustrating a depth estimation system according to one embodiment;

FIG. 3 shows depth maps;

FIG. 4 shows a hardware configuration of the depth estimation deice;

FIG. 5 is a block diagram showing the functional configuration of the depth estimation device;

FIG. 6 is a flowchart illustrating depth estimation processing; and

FIG. 7 shows another example of the depth estimation device.

### DESCRIPTION OF EXEMPLARY EMBODIMENTS

Embodiments of the present disclosure will be described below with reference to the drawings.

Disclosed in the following examples is a depth estimation device that receives a depth map or a depth image (hereinafter collectively referred to as a depth map) inferred by a depth estimation model based on an image (e.g., an RGB image) of a measurement target region, and a depth map acquired from a ranging sensor, and composites the received depth maps in accordance with a cost function that includes later-described constraints. The depth estimation device of the present disclosure can be used to realize depth completion for improving a depth map acquired by a ranging sensor to an image level equivalent to an RGB image, for example. Note that throughout this specification, the term “depth map” refers to two-dimensional data that includes a distance value for each pixel.

### [Overview]

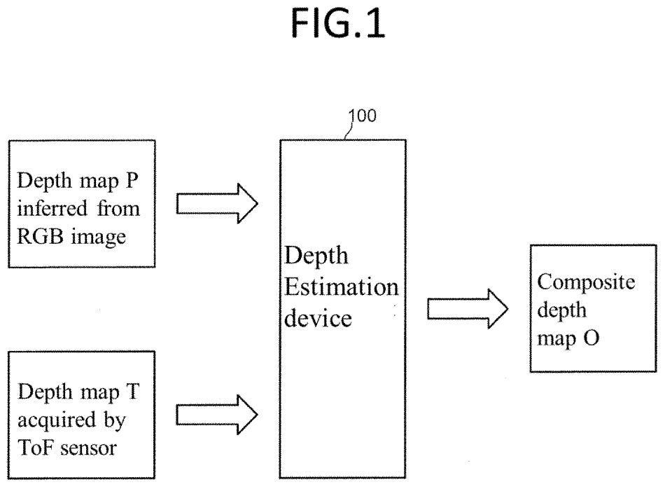

To summarize an embodiment of the present disclosure described below, as shown in FIG. 1, a depth estimation device 100 generates a composite depth map O by compositing a depth map T acquired by a ToF sensor for a measurement target region and a depth map P inferred from an RGB image of the measurement target region by a trained depth estimation model. When generating the depth map O, for each pixel of the depth map O, the depth estimation device 100 uses a cost function to perform processing in which, if the distance value of the pixel is included in the depth map T, that distance value in the depth map T is used as the distance value in the depth map O, whereas if the distance value of the pixel is not included in the depth map T, the distance value in the depth map P is used as the distance value in the depth map O, or the distance value of the pixel in the depth map O is approximated to the distance value of an adjacent pixel.

To achieve such compositing, the depth estimation device 100 composites the depth map T and the depth map P in accordance with a cost function that includes the following three constraints.

Constraint 1: if a distance value corresponding to the pixel of interest is included in the depth map T, the distance value of the pixel of interest in the depth map O is approximated to the distance value in the depth map T.

Constraint 2: if a distance value corresponding to the pixel of interest is not included in the depth map T, the distance value of the pixel of interest in the depth map O is approximated to the distance value in the depth map P. Constraint 3: the distance value of the pixel of interest is approximated to the distance value of a neighboring pixel near the pixel of interest.

According to the depth estimation device 100 of the embodiment described below, when generating the depth map O, distance values in the depth map T are used for pixels that do not have missing distance values in the depth map T, whereas distance values in the depth map P are used for pixels that have missing distance values in the depth map T. As a result, a depth map O that globally has high accuracy can be acquired. Also, since the distance values of pixels in the depth map O are approximated to the distance value of an adjacent pixel when generating the depth map O, it is possible to acquire a depth map O that is smoother between adjacent pixels.

### [Depth Estimation System]

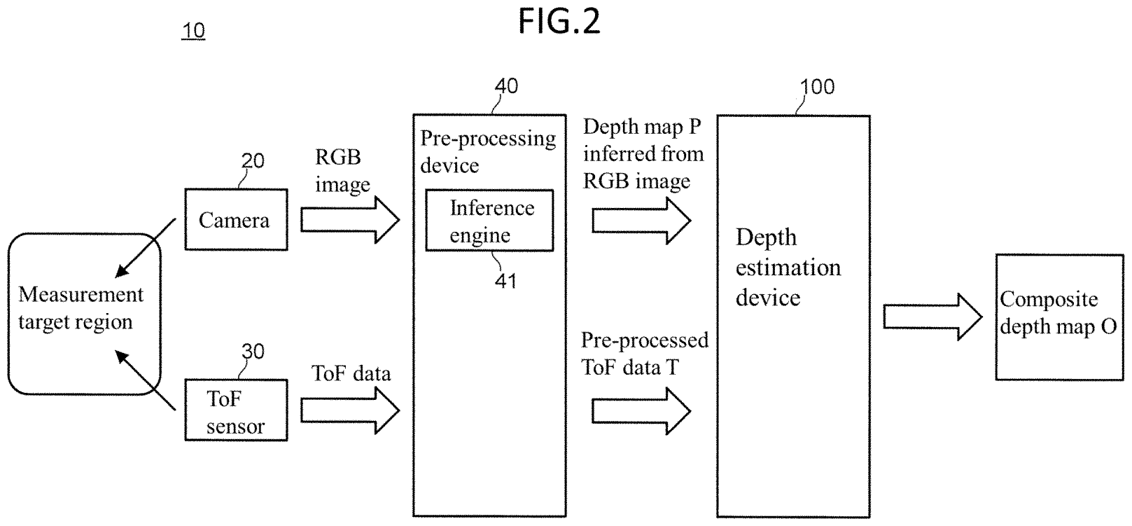

First, a depth estimation system according to one embodiment of the present disclosure will be described below with reference to FIGS. 2 to 4. FIG. 2 is a block diagram illustrating a depth estimation system according to one embodiment of the present disclosure.

As shown in FIG. 2, the depth estimation system 10 includes a camera 20, a ToF sensor 30, a pre-processing device 40, and a depth estimation device 100.

The camera 20 captures an image of a measurement target region and generates an RGB image of the measurement target region. For example, the camera 20 may be a monocular camera and generate a monocular RGB image of a measurement target region that includes a subject. The generated RGB image is passed to the pre-processing device 40. However, the depth estimation system according to the present disclosure is not limited to including the camera 20, and may include any other type of image capturing device that captures an image of the measurement target region. Also, the depth estimation system according to the present disclosure is not limited to using an RGB image, and may acquire or process image data in another format that can be converted into a depth map by the pre-processing device 40 and an inference engine 41.

The ToF sensor 30 detects the distance (depth) between the ToF sensor 30 and subjects in the measurement target region, and generates ToF data or a ToF image (hereinafter collectively referred to as ToF data). The generated ToF data is passed to the pre-processing device 40. However, the depth estimation system according to the present disclosure is not limited to including the ToF sensor 30, and may include any other suitable type of ranging sensor capable of generating a depth map, such as a LiDAR sensor, and may acquire ranging data that corresponds to the included type of ranging sensor. The pre-processing device 40 pre-processes an RGB image acquired from the camera 20 and acquires a depth map P as a result of inference performed by the inference engine 41. Here, the inference engine 41 receives an RGB image as input and outputs a depth map P that indicates the distance (depth) between the camera 20 and subjects in the measurement target region. For example, the inference engine 41 may be an existing depth estimation model such as MiDaS or DPT, or a model trained by (e.g., distilled from) any of one or more existing depth estimation models. Also, the inference engine 41 may be provided in the pre-processing device 40, or a configuration is possible in which the inference engine 41 is provided in an external server (not shown), and the inference result is passed to the pre-processing device 40 via a network.

Specifically, the pre-processing device 40 inputs the acquired RGB image to the inference engine 41 and obtains the depth map P as an inference result. Typically, the depth map P is consistent overall, but does not always represent accurate distance values, and possibly does not represent fine textures. The pre-processing device 40 may rescale the depth map P to match the size of the ToF data T.

On the other hand, the pre-processing device 40 may perform pre-processing such as noise removal on the acquired ToF data. For example, the pre-processing device 40 may execute opening processing on the ToF data to remove isolated pixels. This is because pixels with isolated distance values are likely to be noise. Also, the pre-processing device 40 may perform pre-processing for approximating background pixels of the ToF data to the depth map P. In general, the ToF sensor 30 can favorably perform distance measurement for a range of several meters, and the background portion of the ToF data may be corrected to be closer to the distance values in the corresponding portion of the depth map P acquired by the inference engine 41.

Also, the pre-processing device 40 may reference the ToF data and adaptively bring the central region of the inference result closer to the foreground. A typical characteristic of ToF data is the inability to capture objects that are in a very close range or have a specific color. For this reason, if the ToF data T and the depth map P are composited without performing pre-processing, the depth map O is scaled to the background portion, and a subject in the central portion becomes a portion of the background. The pre-processing device 40 passes the ToF data T and the depth map P that were pre-processed in this manner to the depth estimation device 100.

The depth estimation device 100 composites the ToF data T and the depth map P that were acquired from the pre-processing device 40 in accordance with a cost function to generate the composite depth map O. The cost function according to one embodiment of the present disclosure may include the following three constraints.

Constraint 1: if a distance value corresponding to the pixel of interest is included in the ToF data T, the distance value of the pixel of interest in the depth map O is approximated to the distance value in the ToF data T.

Constraint 2: if a distance value corresponding to the pixel of interest is not included in the ToF data T, the distance value of the pixel of interest in the depth map O is approximated to the distance value in the depth map P.

Constraint 3: the distance value of the pixel of interest is approximated to the distance value of a neighboring pixel near the pixel of interest.

In other words, when the depth estimation device 100 generates the depth map O, distance values in the depth map T are used for pixels that do not have missing distance values in the ToF data T, whereas distance values in the depth map P are used for pixels that have missing distance values in the depth map T. Also, when generating the depth map O, the depth estimation device 100 approximates the distance values of pixels in the depth map O to the distance value of an adjacent pixel. This makes it possible to acquire a smoothed depth map O that globally has high accuracy.

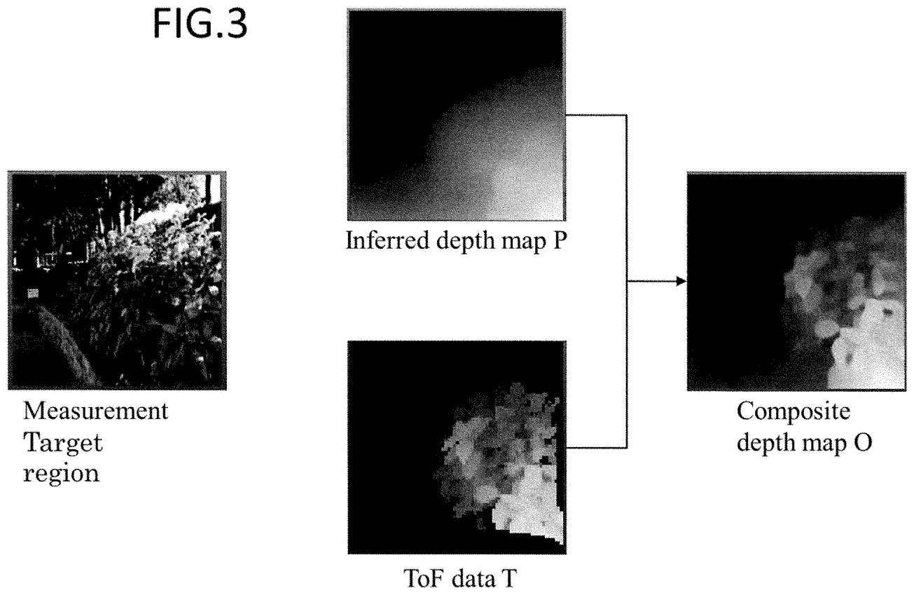

For example, as shown in FIG. 3, when an inferred depth map P and measured ToF data T are acquired for a measurement target region, the depth estimation device 100 can acquire the illustrated composited depth map O in accordance with the above-described cost function. As can be observed from

FIG. 3, the depths of objects in the measurement target region are thought to be more favorably reproduced in the depth map O than in both the ToF data T and the depth map P.

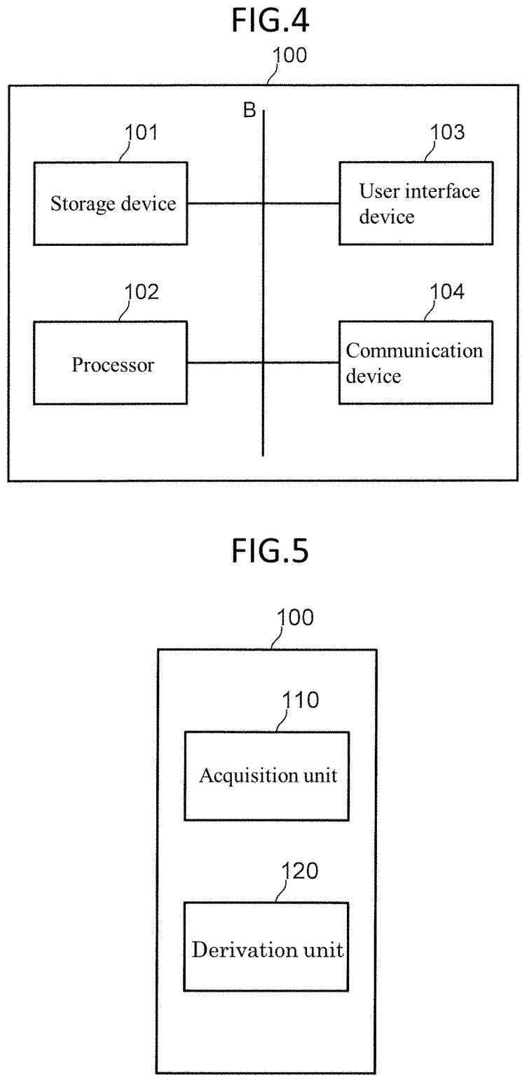

Here, the depth estimation device 100 may be realized by a computing device such as a smartphone, a tablet, or a personal computer, and may have a hardware configuration as shown in FIG. 4, for example. Specifically, in this case, the depth estimation device 100 includes a storage device 101, a processor 102, a user interface (UI) device 103, and a communication device 104, which are connected to each other via a bus B. Programs or instructions for realizing various functions and processing described later in the depth estimation device 100 may be downloaded from any external device via a network or the like, or may be provided via a removable storage medium such as a CD-ROM (Compact Disk-Read Only Memory) or a flash memory.

The storage device 101 is realized by one or more non-transitory storage media such as a random access memory, a flash memory, or a hard disk drive, and stores installed programs or instructions, as well as files, data, and the like used when executing the programs or instructions.

The processor 102 may be realized by one or more CPUs (Central Processing Units), GPUs (Graphics Processing Units), or processing circuits that each include one or more processor cores, for example. The processor 102 executes various functions and processing of the depth estimation device 100, which will be described later, in accordance with programs or instructions stored in the storage device 101 and parameters, data, or the like necessary when executing the programs or instructions.

The user interface (UI) device 103 may include an input device (e.g., a keyboard, a mouse, a camera, or a microphone), an output device (e.g., a display, a speaker, a headset, or a printer), and an input/output device such as a touch panel, and realizes an interface between a user and the depth estimation device 100. For example, the user operates the depth estimation device 100 by using a keyboard, a mouse, or the like to operate a GUI (Graphical User Interface) displayed on a display or touch panel.

The communication device 104 is realized by any of various types of communication circuitry that executes communication processing with an external device or a communication network such as the Internet or a LAN

### (Local Area Network).

However, the hardware configuration described above is merely one example, and the depth estimation device 100 according to the present disclosure may be realized with any other appropriate hardware configuration. For example, the camera 20, the ToF sensor 30, and the pre-processing device 40 may individually or all be incorporated into the depth estimation device 100.

### [Depth Estimation Device]

Next, the depth estimation device 100 according to one embodiment of the present disclosure will be described with reference to FIG. 5. FIG. 5 is a block diagram showing the functional configuration of the depth estimation device 100 according to one embodiment of the present disclosure.

As shown in FIG. 5, the depth estimation device 100 includes an acquisition unit 110 and a derivation unit 120.

The acquisition unit 110 acquires a first depth map acquired by a ranging sensor for a measurement target region and a second depth map inferred from an image of the measurement target region by a trained inference engine. In other words, the acquisition unit 110 acquires the ToF data T and the depth map P from the pre-processing device 40, and passes them to the derivation unit 120.

Here, the ToF data T may be data obtained by the pre-processing device 40 performing pre-processing on the detection result of the ToF sensor 30. Examples of the pre-processing include opening processing for removing noise and correction processing with respect to a background portion.

Also, the depth map P may be data obtained by the inference result of the inference engine 41 with respect to an RGB image captured by the camera 20 being resized so as to match the size of the ToF data T. For example, the ToF data T and the depth map P may be resized to two-dimensional data with a width of 224 pixels and a height of 168 pixels.

The derivation unit 120 derives a third depth map from the first depth map and the second depth map in accordance with a cost function. The cost function includes the following constraints:

a first constraint according to which, if a distance value corresponding to the pixel of interest is included in the first depth map, the distance value of the pixel of interest in the third depth map is approximated to the distance value in the first depth map,

a second constraint according to which, if a distance value corresponding to the pixel of interest is not included in the first depth map, the distance value of the pixel of interest in the third depth map is approximated to the distance value in the second depth map, and

a third constraint according to which the distance value of the pixel of interest is approximated to the distance value of a neighboring pixel near the pixel of interest.

Specifically, the derivation unit 120 generates the composite depth map O by compositing the ToF data T and the depth map P in accordance with the cost function that includes the first to third constraints. In one example, the cost function can be formulated as follows.

$$\begin{matrix}[ Math 1 ] & \\ \begin{matrix}E ( x ) = {( T - x )}^{2} * {1}_{T > 0} + {{w}_{0} ( P - x )}^{2} * {1}_{T = 0} + \frac{{{w}_{1} ( ∇ x )}^{2}}{ϵ + M \sqrt{{( ∇ I )}^{2} + {( ∇ P )}^{2}}} & \end{matrix} & ( 1 )\end{matrix}$$

Here, x is the depth map O, T is the ToF data T, P is the depth map P, and I is the RGB image. Also, w₀, w₁, ε and M are parameters, and V is an operator for obtaining a gradient. The depth map x that minimizes Expression 1 is obtained by the derivation unit 120 as the depth map O.

Here, the first term below on the right-hand side of Expression 1 pertains to the first constraint requiring that, for a pixel for which a distance value exists in the ToF data T, the pixel in the final output x matches the distance value in the ToF data T.

(T−x_²*1_{T>0} [Math 2]

The second term below on the right-hand side of Expression 1 pertains to the second constraint requiring that, for a pixel with a missing distance value in the ToF data T, the pixel in the final output x matches the distance value in the depth map P.

w₀(P−x)²*1_{T=0} [Math 3]

The third term below on the right-hand side of Expression 1 pertains to the third constraint, and the numerator requires approximation of the distance value of the pixel of interest in the final output x to the distance of a neighboring pixel near the pixel of interest, that is to say requires smoothing.

$$\begin{matrix}[ Math 4 ] & \\ \frac{{{w}_{1} ( ∇ x )}^{2}}{ϵ + M \sqrt{{( ∇ I )}^{2} + {( ∇ P )}^{2}}} & \end{matrix}$$

Note that the denominator is for lowering the smoothing effect of the numerator in an edge region between a subject and a background portion.

The parameters w₀ and w₁ are positive weights for balancing the influence of the three terms (in particular, w₀ may be set to a value less than 1 so as to give the ToF data T more influence than the inferred depth map P). Also, the parameter M is a positive weight that specifies how much the smoothing effect is lowered in an edge region. Furthermore, the parameter E is a small positive constant for avoiding division by zero. Note that (∇I)² can be defined as a term for obtaining differential images for the RGB channels and averaging them in the channel direction.

The derivation unit 120 can find x that minimizes Expression 1 as follows. In order to simplify the description, if G is expressed as follows, G is not dependent on x, and can be calculated in advance.

$$\begin{matrix}[ Math 5 ] & \\ G = \frac{{w}_{1}}{ϵ + M \sqrt{{( ∇ I )}^{2} + {( ∇ P )}^{2}}} & \end{matrix}$$

Accordingly, the cost function of Expression 1 can be rewritten as follows.

[Math 6]

E(x0=(T−x)²*1_{T>0}+w₀(P−x)²*1_{T=0}+G*(∇x)² (2)

Since Expression 2 is in the form of the sum of squares of linear expressions, x that minimizes E(x) can be exactly found as the least-squares solution of the linear equation, as shown below.

Here, consider the condition of x where E(x)=0 is satisfied. This is true if the linear expressions of the terms in E(x) are zero. Therefore, it is sufficient that the following equations hold for any pixel (i,j).

[Math 7]

x_{i,j}−T_{i,j}=0 (T_{i,j}>0) \sqrt{w₀}(x_{i,j}−P_{i,j})=0 (T_{i,j}=0) \sqrt{G_{i,j}}(x_{i,j+1}−x_{i,j})=0 \sqrt{G_{i,j}}(x_{i+1,j}−x_{i,j})=0 (3)

Note that, in the following expression, in the situation where the pixel (i,j) is at the right end or the bottom end of the two-dimensional data, and x_{i,j+1} x_{i+1,j} is not defined, then the linear term in which the undefined variable appears is set to zero.

(∇x)_{i,j}²:=(x_{i,j+1}−x_{i,j})²+(x_{i+1,j}−x_{i,j})² [Math 8]

Expression 3 can be expressed as a matrix as shown below.

[Math 9]

Ax=b (4) [Math 9]

Here, the pixels of x are one-dimensionally arranged in raster scan order. Since this linear equation has more conditional expressions than variables, it is an over-determined system, an exact solution does not exist, and it is reasonable to seek a least-squares solution. This least-squares solution corresponds to the exact solution that minimizes (reduces to zero) E(x). Therefore, by finding the least-squares solution of Expression 4, the derivation unit 120 can find x that minimizes the cost function E(x).

As a specific example, consider the case where the ToF data T, the depth map P, the coefficient G, and the final output x are given as shown below.

[Math 10]

| P_{1, 1} | P_{1, 2} |
|---|---|
| P_{2, 1} | P_{2, 2} |
| T_{1, 1} | |
| | T_{2, 2} |
| G_{1, 1} | G_{1, 2} |
| G_{2, 1} | G_{2, 2} |
| x_{1, 1} | x_{1, 2} |
| x_{2, 1} | x_{2, 2} |

Here, the distance value of the final output x is undetermined. Also, T_{1,2} and T_{2,1} are blank, which means that the distance value for that pixel is missing.

For such input, the first term on the right-hand side of the cost function in Expression 2 is as follows.

(T−x)²*1_{T>0}=(x_{1,1}−T_{1,1})²+(x_{2,2}−T_{2,2})² [Math 11]

Also, when w₀=0.01, the second term is as follows.

$$\begin{matrix}[ Math 12 ] & \\ {{w}_{0} ( P - x )}^{2} * {1}_{T = 0} = 0.01 * {( {x}_{1 , 2} - {P}_{1 , 2} )}^{2} + 0.01 * {( {x}_{2 , 1} - {P}_{2 , 1} )}^{2} = {( 0.1 * {x}_{1 , 2} - 0.1 * {P}_{1 , 2} )}^{2} + {( 0.1 * {x}_{2 , 1} - 0.1 * {P}_{2 , 1} )}^{2} & \end{matrix}$$

Furthermore, the third term is as follows.

$$\begin{matrix}[ Math 13 ] & \\ G * {( ∇ x )}^{2} = {G}_{1 , 1} * \{ {( {x}_{1 , 2} - {x}_{1 , 1} )}^{2} + {( {x}_{2 , 1} - {x}_{1 , 1} )}^{2} \} + {G}_{1 , 2} * \{ {( {x}_{2 , 2} - {x}_{1 , 2} )}^{2} \} + {G}_{2 , 1} * \{ {( {x}_{2 , 2} - {x}_{2 , 1} )}^{2} \} = {( \sqrt{{G}_{1 , 1}} {x}_{1 , 2} - \sqrt{{G}_{1 , 1}} {x}_{1 , 1} )}^{2} + {( \sqrt{{G}_{1 , 1}} {x}_{2 , 1} - \sqrt{{G}_{1 , 1}} {x}_{1 , 1} )}^{2} + {( \sqrt{{G}_{1 , 2}} {x}_{2 , 2} - \sqrt{{G}_{1 , 2}} {x}_{1 , 2} )}^{2} + {( \sqrt{{G}_{2 , 1}} {x}_{2 , 2} - \sqrt{{G}_{2 , 1}} {x}_{2 , 1} )}^{2} & \end{matrix}$$

By combining these expressions, the cost function E(x) is as follows.

E(x)=(x_{1,1}−T_{1,1,})²+(x_{2,2}−T_{2,2}_²+(0.1*P_{1,2})²+(0,1*x_{2,1}−0.1*P_{2,1})²+(\sqrt{G_{1,1}}x_{1,2}−\sqrt{G_{1,1}}x_{1,1})²+(\sqrt{G_{1,1}}x_{2,1}−\sqrt{G_{1,1}}x_{1,1})²+(\sqrt{G_{1,2}}x_{2,2}−\sqrt{G_{1,2}}x_{,1,2})²+(\sqrt{G_{2,1}}x_{2,2}−\sqrt{G_{2,1}}x_{2,1})² [Math 14]

In other words, it can be seen that the cost function E(x) is the sum of the squares of linear expressions for x. Therefore, the exact solution x that minimizes the cost can be derived by the least-squares solution of the following linear equation.

$$\begin{matrix}[ Math 15 ] & \\ {( \begin{matrix}1 & 0 & 0 & 0 \\ 0 & 0.1 & 0 & 0 \\ 0 & 0 & 0.1 & 0 \\ 0 & 0 & 0 & 1 \\ - \sqrt{{G}_{1 , 1}} & \sqrt{{G}_{1 , 1}} & 0 & 0 \\ - \sqrt{{G}_{1 , 1}} & 0 & \sqrt{{G}_{1 , 1}} & 0 \\ 0 & - \sqrt{{G}_{1 , 2}} & 0 & \sqrt{{G}_{1 , 2}} \\ 0 & 0 & - \sqrt{{G}_{2 , 1}} & \sqrt{{G}_{2 , 1}}\end{matrix} )}_{\underbrace{A}} ( \begin{matrix}{x}_{1 , 1} \\ {x}_{1 , 2} \\ {x}_{2 , 1} \\ {x}_{2 , 2}\end{matrix} ) = {( \begin{matrix}{T}_{1 , 1} \\ 0.1 * {P}_{1 , 2} \\ 0.1 * {P}_{2 , 1} \\ {T}_{2 , 2} \\ 0 \\ 0 \\ 0 \\ 0\end{matrix} )}_{\underbrace{b}} & ( 5 )\end{matrix}$$

The least-squares solution of Expression 5 can be easily found by singular value decomposition or the like. In this way, the derivation unit 120 can derive x that minimizes the cost function E(x) in a reasonable computation time by finding the least-squares solution of Expression 5, and can acquire the depth map O composited from the ToF data T and the depth map P.

### [Depth Estimation Processing]

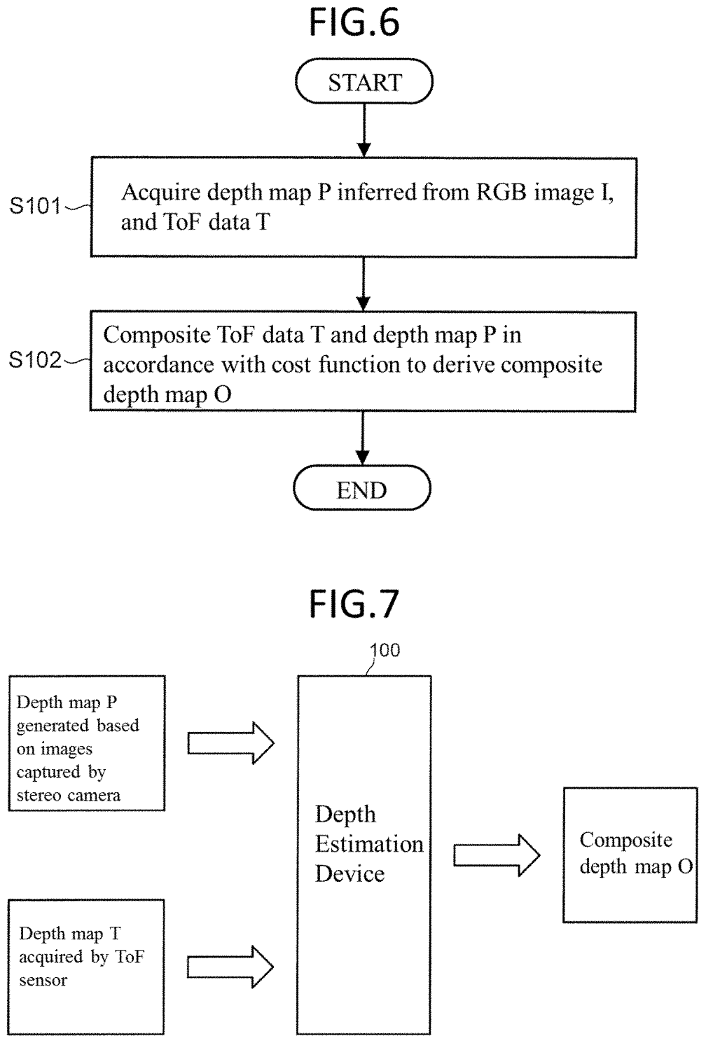

Next, depth estimation processing according to an embodiment of the present disclosure will be described with reference to FIG. 6. The depth estimation processing may be realized by being executed by the depth estimation device 100 described above, or more specifically, by the one or more processors 102 of the depth estimation device 100 executing one or more programs or instructions stored in the one or more storage devices 101. For example, the depth estimation processing can be started by the user of the depth estimation device 100 launching an application or the like related to such processing.

FIG. 6 is a flowchart illustrating depth estimation processing according to one embodiment of the present disclosure.

As shown in FIG. 6, in step S101, the depth estimation device 100 acquires a depth map P inferred from an RGB image I of a measurement target region, and ToF data T. Specifically, the camera 20 captures an image of the measurement target region to acquire the RGB image I, and the ToF sensor 30 performs measurement with respect to the measurement target region to acquire the ToF data that indicates distances between the ToF sensor 30 and objects in the measurement target region.

Next, the pre-processing device 40 pre-processes the acquired ToF data to acquire ToF data T. The pre-processing device 40 also generates a depth map P from the RGB image I with use of the inference engine 41. For example, the ToF data T may be acquired by executing opening processing, correction processing, or the like on the ToF data acquired from the ToF sensor 30. Also, the depth map P may be acquired by executing resizing processing on the inference result of the inference engine 41 so as to match the size of the ToF data T.

The ToF data T and the depth map P acquired in this way are provided to the depth estimation device 100.

In step S102, the depth estimation device 100 composites the ToF data T and the depth map P in accordance with the cost function to derive the composite depth map O. For example, the cost function may include the following three constraints.

Constraint 1: if a distance value corresponding to the pixel of interest is included in the ToF data T, the distance value of the pixel of interest in the depth map O is approximated to the distance value in the ToF data T.

Constraint 2: if a distance value corresponding to the pixel of interest is not included in the ToF data T, the distance value of the pixel of interest in the depth map O is approximated to the distance value in the depth map P.

Constraint 3: the distance value of the pixel of interest is approximated to the distance value of a neighboring pixel near the pixel of interest.

Specifically, the cost function may be formulated as follows.

$$\begin{matrix}[ Math 16 ] & \\ E ( x ) = {( T - x )}^{2} * {1}_{T > 0} + {{w}_{0} ( P - x )}^{2} * {1}_{T = 0} + \frac{{{w}_{1} ( ∇ x )}^{2}}{ϵ + M \sqrt{{( ∇ I )}^{2} + {( ∇ P )}^{2}}} & \end{matrix}$$

Here, x is the depth map O, T is the ToF data T, P is the depth map P, and I is the RGB image. Also, w₀, w₁, ε, and M are parameters, and ∇ is an operator for finding a gradient. The depth estimation device 100 finds, as the depth map O, the depth map x that minimizes the cost function E(x). Here, the depth map x that minimizes the cost function E(x) can be obtained as the least-squares solution of a linear equation obtained when E(x)=0.

According to the embodiment described above, the depth estimation device 100 generates a composite depth map O by using a cost function that includes the following three constraints to composite a depth map T acquired from a ranging sensor and a depth map P inferred from an image from an image capturing device.

Constraint 1: if a distance value corresponding to the pixel of interest is included in the depth map T, the distance value of the pixel of interest in the depth map O is approximated to the distance value in the depth map T.

Constraint 2: if a distance value corresponding to the pixel of interest is not included in the depth map T, the distance value of the pixel of interest in the depth map O is approximated to the distance value in the depth map P.

Constraint 3: the distance value of the pixel of interest is approximated to the distance value of a neighboring pixel near the pixel of interest.

This makes it possible to acquire the depth map O that globally has high accuracy and is smoother between adjacent pixels.

### [Other Embodiments]

In the above embodiment, an aspect is described in which a composite depth map O is generated by using a cost function that includes three constraints to composite a depth map T acquired from a ranging sensor and a depth map P inferred from an image from an image capturing device. However, the combination of depth maps that are composited is not required to be the above combination. As another example, the depth estimation device 100 may generate the depth map P based on images captured by a stereo camera, rather than using a technique of inferring the depth map P from an image from an image capturing device with use of a trained model. It is known that, using the principle of triangulation, it is possible to acquire distance (depth) information from a camera to a subject based on parallax between viewpoints (image capturing points) in two or more images captured by a stereo camera. In the present embodiment, as shown in FIG. 7, the depth estimation device 100 generates the depth map P that includes a distance value for each pixel based on images captured by a stereo camera. The generated depth map P is composited with the depth map T acquired from the ranging sensor using the cost function that includes the three constraints described above, and ultimately the composite depth map O is output.

As mentioned above, simply speaking, the third term on the right-hand side of Expression 1 requires that the distance value at a certain pixel is approximated to the distance value of a neighboring pixel adjacent thereto. In other words, the smoothing of distance values between pixels is required. According to one example, by finding distance values that minimize the cost function of Expression 1, it is possible to perform smoothing between the distance values of adjacent pixels while also suppressing large deviation from the distance values of the input depth map. Here, smoothing means smoothing a plurality of distance values included in one subject, for example. There are cases where overall distance value smoothing is performed by decreasing the difference between the distance values of some pairs of adjacent pixels and increasing the difference between the distance values of other pairs of adjacent pixels. Therefore, smoothing does not necessarily reduce the difference in distance values between all pairs of adjacent pixels. According to one example, the smoothing processing is processing for reducing the average difference between adjacent distance values (distance values of two adjacent pixels). According to another example, when focusing on a certain subject, the smoothing processing is processing for reducing the average difference between adjacent distance values included in the subject. According to yet another example, when focusing on the overall depth map, the smoothing processing is processing for reducing the average difference between all pairs of adjacent distance values in the depth map. According to some examples, the distance value at a certain pixel of the output depth map is different from the distance value at the corresponding pixel in every one of a plurality of depth maps.

Here, consider the case where a certain pixel (hereinafter referred to as the first pixel) and a pixel adjacent to that pixel (hereinafter referred to as the second pixel) are both associated with one subject. In this case, the following A, B, and C hold.

(A) If a distance value for the first pixel and a distance value for the second pixel were both acquired from the depth map P, the difference between these distance values is small, and the effect of smoothing by the third term on the right hand side of Expression 1 is small.

(B) If a distance value for the first pixel and a distance value for the second pixel were both acquired from the depth map T, the difference between these distance values is small, and the effect of smoothing is small due to the third term on the right hand side of Expression 1.

(C) However, if a distance value for either the first pixel or the second pixel was acquired from the depth map P and a distance value for the other one was acquired from the depth map T, the difference between these distance values may be relatively large, in which case the effect of smoothing by the third term on the right-hand side of Expression 1 may be large.

In the case of the one subject described above, if the depth map T is simply used as a base, and a missing portion in the depth map T is supplemented with a portion from the depth map P, the average difference between adjacent distance values becomes a higher value. This similarly applies for the entirety of the depth map. If the average difference between adjacent distance values is large, boundaries between pixels become unnaturally prominent.

On the other hand, in the present embodiment, distance values are smoothed as described above, and therefore the average difference between adjacent distance values is reduced for one subject or for the entirety of the depth map. In one example, the aforementioned distance value smoothing processing is performed for each of a plurality of subjects in the composite depth map. Note that the average difference between adjacent distance values can be reduced by a calculation method other than Expression 1.

Note that in the case where the first pixel is related to a subject and the second pixel is related to a background portion, the first pixel and the second pixel constitute an edge region. In this case, there is a significant difference between the distance value of the first pixel and the distance value of the second pixel. Accordingly, it is desirable to keep the difference between the distance value related to the subject and the distance value related to the background portion. In view of this, in the edge region, the effect of distance value smoothing is lowered by the denominator of the third term in Expression 1. As a result, the difference between distance values in the edge region can be properly maintained instead of being excessively reduced.

In another example, in order to simplify the arithmetic processing, it is possible to match the degree of distance value smoothing in the subject and the degree of distance value smoothing in the edge region. In this case, the denominator in the third term on the right-hand side of Expression 1 can be omitted. In this case, excessive distance value smoothing in the edge region can be prevented by setting a relatively small value for w₁ in the third term on the right-hand side of Expression 1, for example. In yet another example, as shown in Expression 1, it is possible to raise the effect of distance value smoothing in the subject and lower the effect of distance value smoothing in the edge region.

Here, the name of the depth estimation device 100 includes the term “estimation” due to estimating distance values by performing smoothing as described above, rather than simply compositing two depth maps. The depth estimation device 100 can also be called a depth map compositing device or a depth map generation device.

A depth map P acquired by inference from an RGB image and a depth map T obtained by a ranging sensor are given as examples of depth maps that are input to the depth estimation device 100. In another example, other depth maps can be input to the depth measuring device 100. Non-limiting variations of input depth maps are shown below.

### [Example 1]

For example, a depth map S acquired by stereo matching and a depth map W inferred from a wide-angle camera image can be input to the depth estimation device 100. With stereo matching, it is possible to calculate relatively accurate distance values, except for occlusion areas. However, stereo matching can only calculate distance values (depths) corresponding to a telephoto camera, and cannot calculate distance values near the edge of an image captured by a wide-angle camera. On the other hand, with single camera depth estimation with a wide-angle camera, distance values can be estimated for the entirety of the image. In other words, the number of effective pixels in the depth map S is smaller than the number of effective pixels in the depth map W. In view of this, the depth estimation device 100 can create the depth map O by compositing the depth map S and the depth map W in accordance with a cost function that includes the following three constraints.

Constraint 1: if a distance value corresponding to the pixel of interest is included in the depth map S, the distance value of the pixel of interest in the depth map O is approximated to the distance value in the depth map S.

Constraint 2: if a distance value corresponding to the pixel of interest is not included in the depth map S, the distance value of the pixel of interest in the depth map O is approximated to the distance value in the depth map W.

Constraint 3: the distance value of the pixel of interest is approximated to the distance value of an adjacent pixel near the pixel of interest.

In this way, it is possible to generate the depth map O that includes distance values for the entire image. In one example, captured image data necessary for generating the depth map O can be provided by using a combination of a wide-angle camera and a telephoto camera. In another example, depth maps can be composited using another method. For example, in one configuration, when generating the composite output depth map, if a distance value is included in the depth map S, that distance value is used, whereas for a portion where the depth map S does not have a distance value, the distance value in the depth map W is used. In another example, distance values for a central portion of the output depth map may be taken from distance values in the depth map S, and distance values for a peripheral portion surrounding the central portion of the output depth map may be taken from the depth map W.

### [Example 2]

In Example 2, in addition to the depth map S and the depth map W in Example 1, a depth map T acquired by a ranging sensor such as a ToF sensor is also used as an input depth map. In other words, three depth maps are input to depth estimation device 100. The depth estimation device 100 composites the three input depth maps based on the reliability of the input depth maps. In one example, the depth estimation device 100 can generate the composite depth map O based on a cost function that includes the following four constraints.

Constraint 1: if a distance value corresponding to the pixel of interest is included in the depth map T, the distance value of the pixel of interest in the depth map O is approximated to the distance value in the depth map T.

Constraint 2: if a distance value corresponding to the pixel of interest is not included in the depth map T, the distance value of the pixel of interest in the depth map O is approximated to the distance value in the depth map S.

Constraint 3: if both the depth map T and the depth map S do not include a distance value corresponding to the pixel of interest, the distance value of the pixel of interest in the depth map O is approximated to the distance value in the depth map W.

Constraint 4: the distance value of the pixel of interest is approximated to the distance value of an adjacent pixel near the pixel of interest.

In this example, it is presumed that the distance values in the depth map T have the highest reliability, the distance values in the depth map S have the next highest reliability, and the distance values in the depth map W have a lower reliability. Thus, the depth map O can be generated by compositing a plurality of depth maps based on the reliability of the depth maps. In another example, another input depth map can be employed. In yet another example, depth maps can be composited using another method. For example, in one configuration, when generating the composite output depth map, if a distance value is included in the depth map T, that distance value is used, if that distance value is not included in the depth map T, the distance value in the depth map S is used, and if both the depth map T and the depth map S do not include that distance value, the distance value in the depth map W is used.

### [Example 3]

A depth map D obtained by dual camera parallax estimation and a depth map T acquired by a ranging sensor such as a ToF sensor can be input to the depth estimation device 100 as input depth maps. With dual camera parallax estimation, matching cannot be performed for an occlusion region, and therefore such a region is generally an invalid region. If distance values for the invalid region are filled based on distance values of pixels surrounding the invalid region, the invalid region becomes a region in which the distance values have a low reliability. Also, if there is a region that has a repeating pattern or a region that does not have texture, a distance value at one point may be used for distance values at multiple points, and the accuracy of the obtained distance values may decrease.

In other words, regions in the depth map D can be classified as follows.

Region D1: occlusion region (low reliability)

Region D2: repeating pattern region or no-texture region (flat region) (low reliability)

Region D3: region other than regions D1 and D2 (high reliability)

On the other hand, the depth map T obtained by a ranging sensor such as a ToF sensor includes the following regions.

Region T1: occlusion region appearing due to image alignment (low reliability)

Region T2: portion not reached by infrared light (e.g., background) (low reliability)

Region T3: repeating pattern region or no-texture region (low reliability)

Region T4: region other than regions T1, T2, and T3 (high reliability)

Note that if the base image and the ToF or reference image are captured from different directions, occlusion will occur in different directions, and thus such images can be said to be in a complementary relationship.

In this way, the depth maps D and T each include high-reliability regions and low-reliability regions. In view of this, the depth estimation device 100 can generate the composite depth map O based on a cost function that includes the following three constraints.

Constraint 1: if a distance value corresponding to the pixel of interest is included in the region D3 or the region T4, the distance value of the pixel of interest in the depth map O is approximated to the distance value in either of those two regions.

Constraint 2: if both the region D3 and the region T4 do not include a distance value corresponding to the pixel of interest, the distance value of the pixel of interest in the depth map O is approximated to the distance value in the region D1, D2, T1, T2, or T3.

Constraint 3: the distance value of the pixel of interest is approximated to the distance value of an adjacent pixel near the pixel of interest.

As a result, it is possible to generate a highly accurate composite depth map in which regions with high reliability in a plurality of input depth maps are preferentially reflected in the depth map O.

In Example 3 above, regions of the input depth maps are classified into two regions: regions with distance values that have a high reliability, and regions with distance values that have a low reliability. In another example, the regions of the input depth maps can be classified into three or more regions that have different extents of reliability. For example, the depth map D is divided into a region D3 with a high reliability, a region D2 with a lower reliability than the region D3, and a region D1 with a lower reliability than the region D2. The depth map T is divided into a region T4 with a high reliability, a region T3 with a lower reliability than the region T4, a region T2 with a lower reliability than the region T3, and a region T1 with a lower reliability than the region T2, for example. In yet another example, a reliability map is acquired along with distance values for the depth map T acquired by a ranging sensor such as a ToF sensor. On the other hand, for the depth map D, a reliability score is assigned to each region by the pre-processing device, for example. For example, the depth estimation device 100 receives, as an input depth map, data in which a distance value and a reliability score for the distance value are assigned to each pixel. In the case where the depth maps D and T are the input depth maps, in one example, the order of highest reliability for the regions is T4, D3, T3, T2, T1, D2, and D1, and the depth estimation device 100 reflects the distance values in the depth map O in order of highest reliability using a method equivalent to the above-described method using a cost function.

A high-quality depth map can be provided by assigning a reliability for each region of the input depth maps and preferentially reflecting regions with a higher reliability in the output depth map.

1. A depth estimation method comprising:
acquiring a plurality of depth maps; and
outputting one output depth map obtained by compositing the plurality of depth maps with a lower average difference between distance values of adjacent pixels than in a case of directly using distance values included in the plurality of depth maps.

2. The depth estimation method according to claim 1,
wherein a distance value of a pixel in the output depth map is different from a distance value of a corresponding pixel in each of the plurality of depth maps.

3. The depth estimation method according to claim 1,
wherein the plurality of depth maps include a first depth map and a second depth map, and
the depth estimation method further comprises:
acquiring the first depth map with use of a ranging sensor; and
acquiring the second depth map with use of an image capturing device.

4. The depth estimation method according to claim 1,
wherein the plurality of depth maps include a first depth map and a second depth map,
the first depth map is a depth map in which a distance value is missing for at least one pixel, and
the second depth map is a depth map not including a missing distance value.

5. A depth estimation method comprising:
acquiring a first depth map by stereo matching;
acquiring a second depth map obtained by inference from an image; and
outputting an output depth map obtained by compositing a plurality of depth maps including the first depth map and the second depth map.

6. The depth estimation method according to claim 5,
wherein the first depth map includes fewer effective pixels than the second depth map.

7. The depth estimation method according to claim 5,
wherein the image is captured by a wide-angle camera.

8. The depth estimation method according to claim 6,
wherein a distance value in a central portion of the output depth map is taken from the first depth map, and a distance value in a peripheral portion surrounding the central portion of the output depth map is taken from the second depth map.

9. The depth estimation method according to claim 5, further comprising:
acquiring a third depth map obtained by a ToF sensor,
wherein the output depth map is obtained by compositing the first depth map, the second depth map, and the third depth map.

10. A depth estimation device comprising:
an acquisition unit configured to acquire a first depth map acquired by a ranging sensor for a measurement target region, and a second depth map generated from an image of the measurement target region; and
a derivation unit configured to derive a third depth map from the first depth map and the second depth map in accordance with a cost function,
wherein the cost function includes
a first constraint according to which in a case where a distance value corresponding to a pixel of interest is included in the first depth map, a distance value of the pixel of interest in the third depth map is approximated to the distance value in the first depth map,
a second constraint according to which in a case where the distance value corresponding to the pixel of interest is not included in the first depth map, the distance value of the pixel of interest in the third depth map is approximated to a distance value in the second depth map, and
a third constraint according to which the distance value of the pixel of interest is approximated to a distance value of a neighboring pixel near the pixel of interest.

11. The depth estimation device according to claim 10,
wherein the derivation unit derives the third depth map so as to minimize a value of the cost function.

12. The depth estimation device according to claim 10,
wherein the cost function is defined such that the third constraint is weakened in a portion where a distance value in the first depth map or the second depth map is discontinuous.
